(19) United States
(12) Patent Application Publication
(10) Pub. No.: US 2004/0059752 A1
(43) Pub. Date: Mar. 25, 2004

(54) System and method for wirelessly viewing restricted data

(76) Inventors: John Christopher Crandall, Fort Collins, CO (US); Carla Amanda Pasetti, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/252,938

(22) Filed: Sep. 20, 2002

(51) Int. Cl. G06F 17/00; G06F 7/00

(52) U.S. Cl. 707/104.1

(57) ABSTRACT

Disclosed is a system and method of using a hand-held device by a prospective viewer to wirelessly transmit to a control source a request for the delivery to the device of an image of a selected person. The prospective viewer is identified and compared to a list of allowed parties. If a match occurs the desired image is delivered to the hand-held device for viewing by the viewer.

### CROSS-REFERENCE TO RELATED APPLICATIONS

The present application is related to commonly assigned U.S. patent application Ser. No. [Attorney Docket No. 10018883-1] “SYSTEM AND METHOD FOR CAPTURING IMAGES BASED UPON SUBJECT ORIENTATION,” U.S. patent application Ser. No. [Attorney Docket No. 10018893-1] entitled “SYSTEM AND METHOD FOR CONTROLLING SERVICE DELIVERY,” and U.S. patent application Ser. No. [Attorney Docket No. 10018884-1] entitled “SYSTEM AND METHOD FOR MONITORING WITHIN A VEHICLE,” filed on the same date herewith, the disclosures of which are hereby incorporated by reference in their entireties.

### BACKGROUND

People find themselves confined to hospitals, rest homes, assisted living facilities and the like, for a variety of reasons. Some of those reasons are happy occasions, such as the birth of a child. Some of those reasons are far less joyous. Regardless of why such confinement occurs, many people not so confined often have reason to have visual contact with those that are confined.

For example, when a child is born it is very natural for the mother to wish to see the child even while the child is sleeping in a remote nursery. The desire to see the child increases when the new-born is under treatment for a medical condition. This desire is also true, as another example, for parents whose child is undergoing, or recovering from, a hospital procedure.

Today, the child must be brought to the parent, or the parent must go to the child, and view the child from afar, usually through a glass partition. Often such visits are not possible, either because the parent or the child are unable to be moved. Also, the normal schedules of such institutions are such that they cannot accommodate a visitor's schedule.

Sometimes, friends or family travel to an institution to visit an occupant and the occupant is not available, or visiting hours are over, or for a number of other reasons, the visitor is not able to see the occupant. These situations are all most unsatisfactory to all concerned.

### SUMMARY

Embodiments of the teachings of the invention provide a hand-held device for use by a prospective viewer comprising means for wirelessly transmitting to a control source a request for the delivery to the device of an image of a selected person, means for identifying the prospective viewer, means for receiving the delivery of the selected image, and means for displaying the received, selected images.

Additionally, embodiments of the teachings of the invention provide a system for retrieving digital images from a file, comprising a storage device for storing digital data images, each such image being retrievable only by a limited set of users, the users physically separate from the storage device, an image control system for obtaining from the storage device a specific data image upon command of one of the users, and a plurality of viewers wirelessly coupled with the image control system, each viewer for use by any user. Wherein each viewer includes an input for accepting from a specific user the identity of the specific user, an identity of a desired image, a desired presentation format, and the viewer including circuitry for communicating wirelessly to the image control system the accepted identity, the accepted desired image and the accepted desired format, such that the image control system may thereupon obtain from the storage device the desired image using the communicated specific user identity.

Embodiments of the teachings of the invention further provide a method for allowing users to view the images of certain people confined to an institution comprising, under control of a prospective viewer, sending a wireless message to a database, the message including an identity of the prospective viewer, and an identify of an image of a person so confined to be viewed by the prospective viewer, and then processing the wireless message to determine if the requesting prospective viewer, based on the message identity, has been given permission to view the requested image.

### BRIEF DESCRIPTION OF THE DRAWINGS

FIG. 1 is an overview of an embodiment of a system in accordance with the teachings of the invention;

FIG. 2 is a flow chart of one embodiment of an image capture portion in accordance with the teachings of the invention;

FIG. 3 is a flow chart of one embodiment of a request processing portion in accordance with the teachings of the invention;

FIG. 4 is a flow chart of one embodiment of an image requesting process in accordance with the teachings of the invention; and

FIG. 5 is a flow chart of one embodiment of an image receiving process in accordance with the teachings of the invention.

### DETAILED DESCRIPTION

The present inventive teachings are directed to a system and method for enabling an occupant of an institution (or a visitor) to visually observe a desired person (such as a new-born) by use of a monitor remote from the person to be viewed.

In one embodiment, images of the target person (or other object) are captured and stored in a database in association with a list of those who can view the images. The viewer then, using the remote monitor, indicates which images he/she desires to view. The selected images are copied from the database and wirelessly sent to the monitor for viewing by the requesting viewer.

In an embodiment, the requesting viewer then may take action with respect to each retrieved image. For example, the action taken could be to have a certain image printed. Or the viewer could request that the image be transmitted to someone else, or removed from the database. Any number of such actions can be taken by the viewer.

FIG. 1 is an overview of a system according to an embodiment in accordance with the teachings of the invention and shows system 10 in which a enterprise imaging system 11, such as that shown and described in the above referenced patent application entitled “SYSTEM AND METHOD FOR CONTROLLING SERVICE DELIVERY,” receives images from an imaging source, such as camera 101, scanner 102, or any other input 103. These other inputs 103 could be from a computer, the Internet, a card scanner capable of scanning credit cards, or other cards having information thereon in various forms, including Smart Cards, or the like. The information from these other inputs 103 is stored together with information pertaining to the identity of the person (or persons) who have permission to withdraw the information from database 12, as will be discussed hereinafter. In one embodiment, the information includes images of hospital patients, such as babies, which are obtained in the defined space of the hospital and can be viewed, if desired, only in that space.

Control 14 controls the selection of an image, for example specific image 13 and can provide the image to a printer 313, e-mail location 316, or to marking process 16, or provide the image for other purposes 315. Also, the image can be transmitted via wireless path 15 to a handheld viewer 16, the viewer having on it screen 17 to view the specific image 13 and keypad or other input device 18 to facilitate transmitting the messages or other information to a third party. Keypad 18 can be keys of a keyboard, magnetic stripe readers, sound, or voice activated devices. The images could be maintained for a fixed period of time, or forever, if desired, and the time can be noted therein.

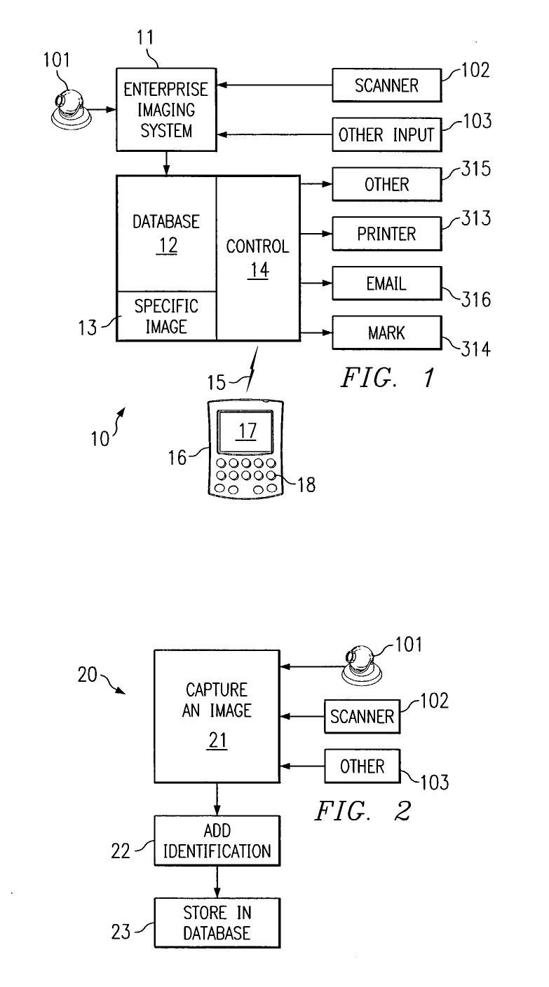

FIG. 2 is a flow chart of one embodiment of an image capture portion in accordance with the teachings of the invention and shows flow diagram 20 of an embodiment of the invention where the images are captured via a capture device, which could be, for example, camera 101, scanner 102, or any other device 103. Identification is added to the captured images via process 22 and the data, including the captured images and identification information, is stored in database under control of process 23. The added identification can be, for example, a list of all those who can subsequently retrieve an image, or it can be a family name, or a special code, or an affinity group, such as police, co-workers, employer, etc.

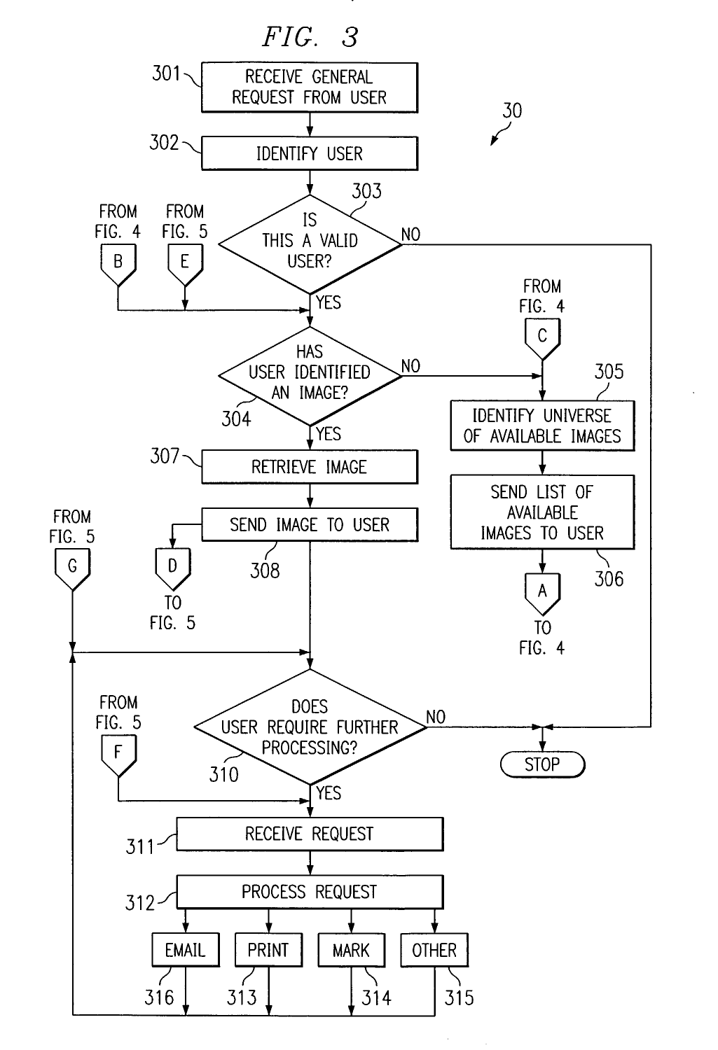

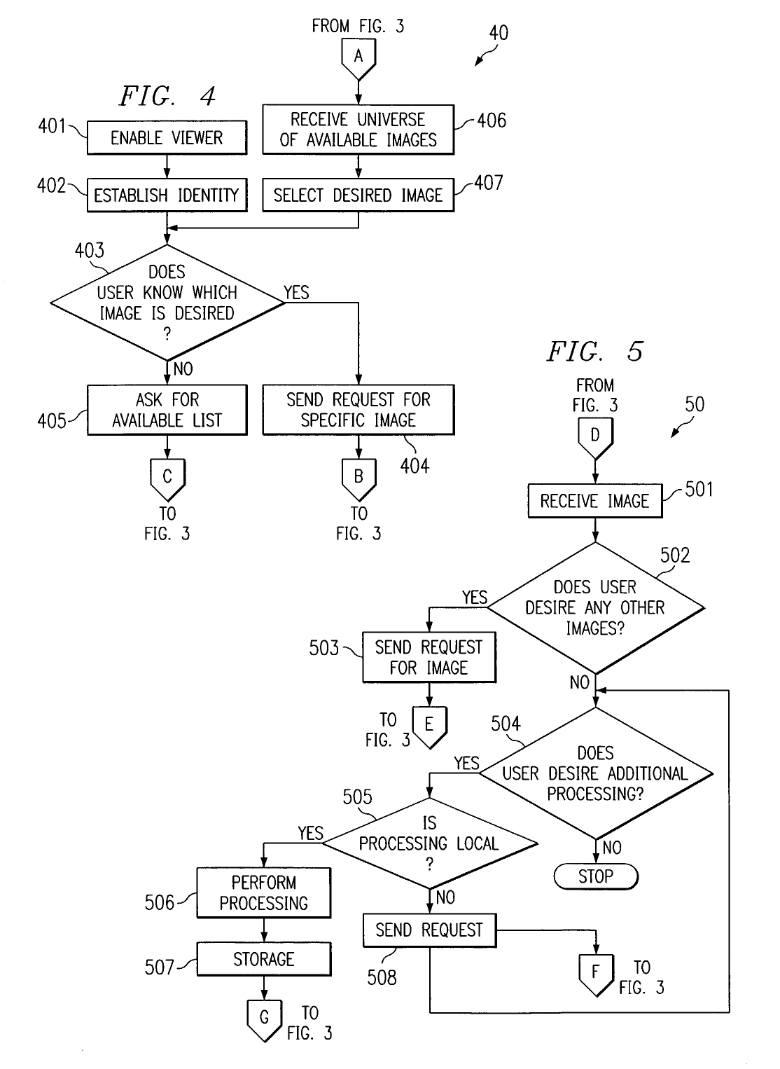

FIG. 3 is a flow chart of one embodiment of a request processing portion in accordance with the teachings of the invention and shows flowchart 30 which is one embodiment of operation of a system for receiving requests from a user, processing requests, and presenting images according to the present invention. Flow chart 30 begins at process 301 where general requests are received from a user. Process 302 identifies the user and valid identification is made at process 303. This identification is made, for example, by comparing the user to the terminal. If the identification is not valid, processing is stopped. If the identification is valid, then a determination is made as to whether the user has identified an image in process 304. If not, then the system identifies a universe of available images (those images available to this terminal and this user) via process 305 and, if desired by the user, sends such a list to the user via process 306. Once the user has identified an image, the image is retrieved via process 307 and the image is sent to the user via process 308. When the image has been sent, then a check is made at process 310 as to whether the user needs further processing. When the answer is “yes”, then the requests are received via process 311, the requests are processed via process 312, and perhaps the user has identified that a particular image is to be printed (313), marked (314), e-mailed to another person (316), or whether another operation is to be performed (315). An example of marking could be to keep the image, or other data, for a specific period of time or for later recovery or transmission. At the completion of process 313, 314, 315 or 316 the system repeats via process 310.

If the answer is “no” in process 310, system 30 stops and waits for a re-initiation of the system by the same or another user.

FIG. 4 is a flow chart of one embodiment of an image requesting process in accordance with the teachings of the invention and shows flow chart 40, which is typically operating at TV viewer 16 (FIG. 1) such that the user can follow instructions on the screen to obtain an image or other data. This is enabled at process 401 and the identity of the user is established via any one of a number of systems or methods at process 402. These systems or methods could be, for example, by identifying the device, by checking the manual entry of a viewer ID, by validating a fingerprint or other biometric of the user, by using a magnetic stripe or other identifying means or the like. Then a determination is made as to whether a user knows which image is desired via process 403. If “yes”, then a request is sent via process 404 for the specific image, and that request is processed as discussed above with respect to FIG. 3. If the user does not know which image he/she desires, then the user requests available images via process 405. This request is processed as discussed above in FIG. 3. When the universe of available images are received via process 406, the user can select the desired image via process 407. The selected image is processed via process 403 and 404 as discussed above.

FIG. 5 is a flow chart of one embodiment of an image receiving process in accordance with the teachings of the invention and shows flowchart 50, which is typically operating at viewer 16 (FIG. 1) under control of the user as discussed above. When an image is received at process 501, the question: Does the user desire any other images? is then presented at process 502. If the answer is “yes”, then a request for the other images at process 503 is provided and processed as discussed above. If the user does not desire any other images the question becomes: Does the user desire additional processing? at process 504. If the user does not desire additional processing with respect to the images, the process of flowchart 50 stops. If the answer in process 504 is “yes”, then a determination is made as to whether the processing is local at process 505. If the processing is not local then the request is transmitted via process 508 and this continues until all requests are finished. If the processing is local then process 506 performs the processing with respect to the images and process 507 stores the processed images.

Local processing could be local printing or adding information to an image, or the like. This local processing could be accomplished and the image sent back to the database, or, if desired, forwarded on to a third party, via e-mail. The selected image could be posted on a web site under control of the user, if desired. Posting could be particularly appropriate when the image is that of a newborn child and one wants to share the joy with other family members or friends. The prospective viewer could, using device 16, send instructions to the system for having the system send images to selected third parties, controlled in part, by process 506.

The wireless communication link can be, for example, Blue Tooth, or the 802.11 protocol and can be transmitted using one or more of the unlicensed frequencies, such as, for example, 900 Mhz and 2.4 Ghz. The system can serve multiple users at the same time using techniques such as TDMA, CDMA and the like.

The system can be arranged to allow an image to be viewed by a single viewer or by a group of viewers. The group can be defined as family relationships, or by professional relationships (doctors, social workers, health care workers, etc.) or by friendships or work-related groups.

What is claimed is:

1. A device for use by a prospective viewer, said device comprising:
means for wirelessly transmitting from a hand-held device to a control source a request for the delivery to said device of a selected image of a selected person;
means for identifying said prospective viewer;
means for wirelessly receiving said delivery of said selected image at said hand-held device; and
means for displaying received selected images at said hand-held device.

2. The system of claim 1 wherein said image is initially captured within a defined space, and wherein said hand-held device is operable only within said defined space.

3. The method of claim 2 wherein said defined space is a medical care facility and said image is of a person confined within said facility.

4. The system of claim 1 further comprising:
means enabled from said device for transmitting selected ones of said received images to a third party.

5. A system for retrieving digital images from a file, said system comprising:
a storage device for storing digital data images, each such image being retrievable only by a limited set of users, said users physically separate from said storage device;
a control for obtaining from said storage device a specific data image upon command of one of said users;
a plurality of viewers wirelessly coupled with said image control system, each said viewer for use by any user; each said viewer including an input for accepting from a specific user:
the identity of said specific user;
an identity of a desired image;
a desired presentation format; and
said viewer operable for communicating wirelessly to said control said accepted identity, said accepted desired image and said accepted desired format, such that said control may thereupon obtain from said storage device said desired image using said communicated specific user identity.

6. The system of claim 5 wherein said image control system includes a transmitter operable for delivering said obtained image to said user in said desired format.

7. The system of claim 5 wherein said desired format is selected from the list including, displayed images on a viewer screen, printing said desired image at a printer and marking said desired image for later retrieval.

8. The system of claim 5 wherein said system is established within a defined community and said digital images include photographic images placed in said storage other than by said limited set of users.

9. The system of claim 5 wherein each said stored image includes a relationship keyed to said identity of potential users.

10. The system of claim 5 wherein said identity of a specific user is the identity of said viewer and wherein said storage device maintains a relationship between said stored image data and a specific one of said viewers.

11. The system of claim 5 wherein each said viewer has an identity keyed to a specific user of said viewer.

12. The system of claim 5 further comprising:
circuitry allowing said user to forward to another party images transmitted to said user.

13. A method for allowing users to view the images of certain people confined to an institution, said method comprising:
under control of a prospective viewer, sending a wireless message to a database, said message including an identity of said prospective viewer, and an identity of an image of a person so confined to be viewed by said prospective viewer;
processing said wireless message to determine if said requesting prospective viewer, based on said message identity, has been given permission to view said requested image, and
wirelessly transmitting said requested images to said prospective viewer if said requested viewer is determined to have permission for the requested image.

14. The method of claim 13 wherein said transmitting process is enabled for use by a plurality of different prospective viewers.

15. The method of claim 13 further comprising:
capturing images of certain of confined people; and
associating each such captured image with a universe of prospective viewers, said processing process, in part, relying on said association.

16. The method of claim 13 further comprising:
transmitting said requested images to a party other than said prospective viewer if said requesting viewer is determined to have permission for the requested image.

17. The method of claim 16 wherein said other party is selected by said prospective viewer.

18. The method of claim 16 wherein said other party is selected by said processing steps.

19. The method of claim 13 further including:
under control of said prospective viewer, wirelessly selectively forwarding to a third party images transmitted to said prospective viewer.
